(19) United States
(12) Patent Application Publication
(10) Pub. No.: US 2021/0031376 A1
(43) Pub. Date: Feb. 4, 2021

(54) Multi-Tool Apparatus With Extendable Work Envelope For Machining A Target Slab

(71) Applicant: BACA Systems, LLC, Orion Township, MI (US)

(72) Inventors: Scot Lindemann, Holland, MI (US); Doug Cicchini, Clarkston, MI (US); Rhett King, Oxford, MI (US); Chuck Russo, Rochester Hills, MI (US)

(73) Assignee: BACA Systems, LLC

(21) Appl. No.: 16/530,872

(22) Filed: Aug. 2, 2019

(51) Int. Cl. B25J 11/00; B26F 3/00; B26D 7/00

(52) U.S. Cl. CPC B25J 11/0055; B26D 7/0006; B26F 3/004

(57) ABSTRACT

A multi-axis machining tool is mounted on an asymmetric movable member driven by a motor housed in a sealed, stationary base. The asymmetric movable member is horizontally fixed and rotates about a central vertical axis in synchrony with the machining tool in order to increase the work envelope of the machining tool. Further, the machining tool has a first tool mounted on a tool head as well as second tool mount that may receive a second tool on the tool head without necessitating the removal of the first tool. The second tool is operable while the first tool is still mounted on the tool head. The machining tool may receive instruction from an operator or through pre-programmed code to couple or decouple the second tool without physical decoupling or coupling by the operator.

### BACKGROUND

### a. Technical Field

The technical field of the present disclosure generally relates to robotic machining apparatuses.

### b. Background Art

This background description is set forth below for the purpose of providing context only. Therefore, any aspects of this background description, to the extent that it does not otherwise qualify as prior art, is neither expressly nor impliedly admitted as prior art against the instant disclosure.

In the art, the term machining is generally applied to a variety of applications in the broad world of manufacturing, such as cutting, turning, milling, drilling, planning, bending, sawing and grinding. In one application, multi-axis cutting machines are used for the cutting of slabs of natural and artificial stone, glass, ceramic and metal. These cutting machines may be embodied as one or more cutting tools mounted on a robotic multi-axis and multi-part member (or “robotic arm”), where the various members of the robotic arm work in synchrony to manipulate the cutting tool and perform measured and precise cuts on a target slab. The arm and the synchrony movements may be controlled by a processor within a computer that receives instruction inputs from either a manual user or pre-determined set of load instructions.

Multi-tool heads. The cutting tool may comprise a saw or a water jet mounted on a spindle. Both types of tools are capable of performing cuts on a fixed slab and may be used individually or in combination depending on the application. Water jet cutting deploys a jet of water at a high pressure and may include suspended granules of abrasive material that is directed in a guided manner toward the target slab. A cutting saw may be a bladed circular saw or the like, as commonly used in the art.

In the art, bladed saws can rapidly and efficiently perform cuts while water jet cutting tools offer increased versatility. Both saws and water jet cutting tools may also perform angled cuts, such as miter cuts, depending on the inputs provided to them. Depending on the application and the inputs, it is often desirable to perform cuts with both types of cutting tools on the same slab. Therefore, it is desirable to transition between various cutting tools quickly and efficiently and in a manner that minimizes the change to the cut point of the overall apparatus or otherwise does not necessitate a re-calibration of the robotic arm or revision of the instruction inputs.

Prior art discloses the mounting of various types of cutting tools, but these designs suffer from practical flaws. For example, U.S. Patent Publication No. 2008/0110311 to Stangherlin discloses an overhead horizontal member with a track (i.e., a gantry-style cutting tool) supporting a saw cutting tool and a water jet cutting tool simultaneously. The cut point of the saw cutting tool and the cutting point of the water jet cutting tool differ substantially and are fixed along the same horizontal cutting axis. In order to use the water jet to continue a cut started by the saw, the overhead member must be repositioned in order to position the water jet in the location just vacated by the saw. Because the two tools are fixed on a horizontal axis with fixed portion of space between them, there are significant portions of the slab that are not within the possible cutting zone of the water jet, no matter how the overhead member is positioned. For example, and water jet cannot perform cuts at the far edge of the slab nearest the saw because the saw mount will prevent the water jet from reaching the end of the track.

The cutting apparatus, U.S. Patent Publication No. 2006/0135041 to Boone discloses a similar mounting structure as 2008/0110311. Therefore, it suffers from near identical design flaws that limit its practical application.

Therefore, it is desirous to have machining apparatus where a saw cutting tool, a water jet cutting tool, or other machining tools can be mounted simultaneously and where an operator can switch between the operation of multiple cutting tools without an imprecise and time consuming manual adjustment.

Work Envelope. In the art, using a robotic machining apparatus to perform operations on a fixed slab presents a number of practical problems. Every robotic machining apparatus has a work envelope, i.e., the working area of the machining apparatus that the machining apparatus is able to affect from a fixed position. Because the target slabs are usually fixed in place and can vary substantially in size, machining projects may present target slabs with areas that are outside of a machining apparatus's work envelope. Generally, problem areas are the far corners of the target slab, and, if a side-mounted machining apparatus, the area of the target slab closest to the base of the machining apparatus. Therefore, in order to perform operations on these problem areas either the machining apparatus must be repositioned or the target slab must be moved.

In the art, it is generally impractical and dangerous to move slabs, and therefore prior art solutions have presented various remedies whereby the machining apparatus may move in synchrony with a base mounted on a horizontal or vertical track. One prior solution is to incorporate an overhead track as a gantry-style tool. Conversely, a robotic arm member may be mounted on vertical or horizontal track that moves in synchrony with the robotic arm per the instruction input from a computer or operator. The horizontal and vertical linear movement of the base may allow the robotic arm to reach the far edges of the slab that would be otherwise inaccessible from a central base position.

These prior art linear-track designs suffer from practical flaws. Fixed linear-tracks occupy a substantial amount of space on a work floor, severely reducing the number of machining tools that may operate on the floor at one time when compared to stationary machining tools.

Maintenance. In the art, fixed-track designs shift a mounted object to specified coordinates. Shifting positions on a track exposes the rails, bearings, rack and pinion/ball screw to the open environment of the workspace. Due to the movement of machining tools on the tracks, the tracks and machining tools cannot be completely covered or sealed from dust or debris. Breakdowns and maintenance projects for linear-track based machining tools are common and expensive. Gantry track designs present particularly difficult maintenance issues due to the inaccessible nature of the overhead design.

In the typical cutting environment of a stone shop or similar application, the workspace is routinely flooded with water and covered in fine, silty debris. The debris from the machining operations is consistently ejected into the air. The debris and water may form a corrosive slurry in high volumes, which coats the equipment and interferes with internal mechanisms.

Prior art systems deployed to alleviate the debris issue for linear-track systems are confined to covering the mechanisms and tracks by means of a bellows. However, these bellows quickly accumulate mud and debris and will wear down, and ultimately fail to keep environmental hazards and corrosive effects away from the internal mechanisms.

Therefore, it is desirable to mount a machining apparatus on a base that may allow the machining apparatus to perform cuts outside of its natural starting work envelope and is effectively sealable against debris from cutting projects. It is further desirable to perform cuts from a bases that is able to move in synchrony with the cutting apparatus and cutting tool(s) while minimizing the amount of space the apparatus occupies on the manufacturing floor.

The foregoing discussion is intended only to illustrate the present field and should not be taken as a disavowal of claim scope.

### SUMMARY

In an embodiment, a programmable six-axis robotic arm supporting a tool head with a machining tool assembly fixed to a movable member and a base assembly is disclosed. The movable member is horizontally fixed about a vertical axis and is rotatable about the vertical axis. The robotic arm and the movable base are controlled by a computer with a processor, configured to execute code relating to performing operations on target slabs. The movable member is independently movable with respect to the robotic arm and is controlled by the computer to move in synchrony with the robotic arm when performing operations on target slabs. The movable member is rotatably mounted to a fixed base containing a motor. The robotic arm may be fixed to the movable member in a manner offset from the center of the movable member and further may be mounted on an extended member of the movable member that extends beyond the fixed base.

At the distal end of the robotic arm is a wrist joint supporting a wrist member with the tool head comprising the machining tool assembly. In an embodiment, the tool head comprises a first tool, and in another embodiment, comprises the first tool and a second tool. The first tool may be a water jet cutting tool directly mounted to the tool head. The water jet cutting tool is capable of directing a high pressure jet of water onto the fixed slab at a point along the axis formed by the wrist joint of the robotic arm. The water jet cutting tool may receive water from a first coil that is spirally wrapped upwards around the wrist member until it reaches the wrist joint, whereby the first coil is further continuously wrapped around the length of the robotic arm until it reaches the base assembly and a water source.

At the distal end of the wrist member, adjacent to the first tool in manner not interfering with the operating of the first tool, is a second tool mount. The second tool mount can receive a second tool, in an embodiment a saw cutting tool, in a manner that prevents the operation of the first tool but that does not require the first tool to be removed for the mounting or operation of the second tool. When mounted on the robotic saw mount, the second tool is operatively connected to the tool head of the wrist member, the robotic arm and computer. In an embodiment, the saw cutting tool is capable of making direct cuts onto the fixed slab at a point along the axis formed by the wrist joint of the robotic arm. When mounted, the saw cutting tool can receive water from a second coil carried to the wrist member by the robotic arm. In an embodiment, the tool head may automatically couple and decouple with the second tool as the application requires, without direct physical intervention by the operator.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is a profile view of the machining apparatus, in an embodiment.

FIG. 2 is a top-down view of the machining apparatus, in an embodiment.

FIG. 3 is focused view of the base assembly and the movable member of the machining apparatus, in an embodiment.

FIG. 4 is a top-down focused view of the base assembly and the movable member of the machining apparatus, in an embodiment.

FIG. 5A is a view demonstrating the increased work envelope of a machining apparatus exhibiting the features as described in this disclosure, in an embodiment.

FIG. 5B is an alternative view demonstrating the increased work envelope of a machining apparatus exhibiting the features as described in this disclosure, in an embodiment.

FIG. 6A is a focused view of the tool head of the machining apparatus bearing a first tool and a second tool simultaneously, in an embodiment.

FIG. 6B is an alternative focused view of the tool head of the machining apparatus bearing a first tool and a second tool simultaneously, in an embodiment.

FIG. 7A is a focused view of the tool head of the machining apparatus bearing a first tool with the second tool decoupled, in an embodiment.

FIG. 7B is an alternative focused view of the tool head of the machining apparatus bearing a first tool with the second tool decoupled, in an embodiment.

### DETAILED DESCRIPTION

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It will be appreciated that the terms “proximal” and “distal” may be used throughout the specification. The term “proximal” refers to an area closest to the reference point and the term “distal” refers to an area located furthest from the reference point. It will be further appreciated that for conciseness and clarity, spatial terms such as “vertical,” “horizontal,” “up,” and “down” may be used herein with respect to the illustrated embodiments. However, robotic arms and machining tools may be used in many orientations and positions, and these terms are not intended to be limiting or absolute.

Throughout this disclosure, references will be made to cuts made on a stone slab. The reference to a stone slab is exemplary only and does not explicitly or implicitly disclaim a variety of machining operations made on other materials such as artificial stone, plastic, ceramic, carbon-fiber, or glass. Additionally in this disclosure, references to saw cutting tools and water jet cutting tools are made in various embodiments. However, references to these two cutting tools are exemplary only and do not explicitly or implicitly disclaim other forms of machining tools, cutting or otherwise, that may be utilized on a target object, such as, for example, router bits and polishers. Further, the robotic arm as disclosed may be employed in various different affecting embodiments with various tools that do not involve cutting, all of which are contemplated by this disclosure even if not specifically mentioned.

Further, within this disclosure, references may be made to a cut point of a cutting tool. The cut point is the area in front of the cutting tool that is affected by the operation of the cutting tool.

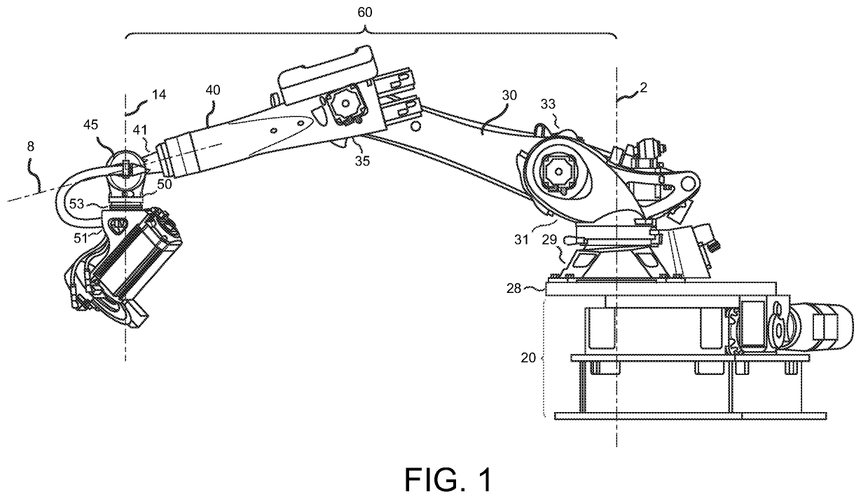

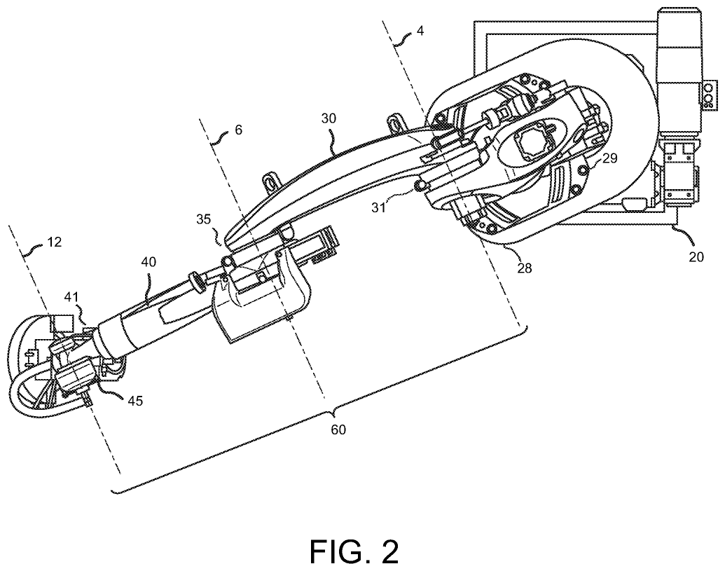

Referring now to the drawings wherein like reference numerals are used to identify identical or similar components in the various views, FIGS. 1 and 2 depict a machining apparatus consistent with some of the embodiments of this disclosure. In an embodiment, a programmable six-axis robotic arm supporting a tool head assembly fixed to a base assembly and a movable member is disclosed.

A six axis robotic arm 60 may be described as having six degrees of freedom with movement about six different axes 2, 4, 6, 8, 12, and 14, shown in FIGS. 1 and 2. The robotic arm 60 comprises a robotic base 31, a lower member 30, an upper member 40 and a wrist member 50. The robotic base 31 is fixed at a first end to a robotic footing 29 that secures the robotic arm 60 to a structure. In this embodiment, the robotic footing 29 is secured to a movable member 28, affixed to a stationary base assembly 20, as described in more detail herein.

The robotic base 31 is capable of rotating about a first axis 2, relative to the robotic footing 29. In an embodiment, the robotic base 31 is capable of rotating 360 degrees about first axis 2.

The robotic base 31 is attached at a second end to the lower member 30 via a shoulder joint 33. Lower member 30 rotates about a second axis 4, which runs through shoulder joint 33 and is perpendicular to the lower member 30. The shoulder joint 33 permits lateral movement of the lower member 30 in a manner that extends the lower member 30 forward and backward relative to the robotic base 31. By virtue of robotic base 31 and the shoulder joint 33, the robotic arm 60 may be independently movable with respect to the movement of the movable member 28. Further, the robotic arm 60 and the movable member 28 may move in synchrony by virtue of a computer with a processor executing code to complete machining actions.

The lower member 30 is attached to the upper member 40 via an elbow joint 35. Upper member 40 rotates about a third axis 6, which runs through the elbow joint 35 and is perpendicular to the lower member 30 of the robotic arm 60. The elbow joint 35 permits lateral movement of the upper member 40 independent of the lower member 30.

The upper member 40 is attached to the wrist member 50 via a wrist rotational member 41 in communication with a wrist joint 45 and wrist member 50. The wrist member 50 rotates about a fourth axis 8, which runs through the wrist rotational member 41 and is parallel to the upper member 40 and the wrist rotational member 41. The fourth axis 8 may be referred to as the “wrist roll” in that it rotates the wrist joint 45 and wrist member 50 in a circular motion.

The wrist member 50 also rotates about a fifth axis 12, which runs through the wrist member 50 and is perpendicular to the upper member 40 and the rotational member 41. Movement about the fifth axis 12 is permitted by the wrist joint 45. The wrist joint 45 may permit the pitch and yaw of the wrist member 50 about the fifth axis 12 and defines the affecting angle of any tool(s) connected to the wrist member 50.

The wrist member 50 is attached to a tool head 51 via a head rotational member 53. The tool head 51 rotates about the sixth axis 14, which runs through the head rotational member 53 and is parallel to the wrist member 50. The head rotational member 53 may permit full 360 degree rotational manipulation of the machining tool(s) about the sixth axis 14. While the embodiment contemplates a six axis robotic arm, the forthcoming concepts may be applied to robotic members with varying degrees of freedom or axes.

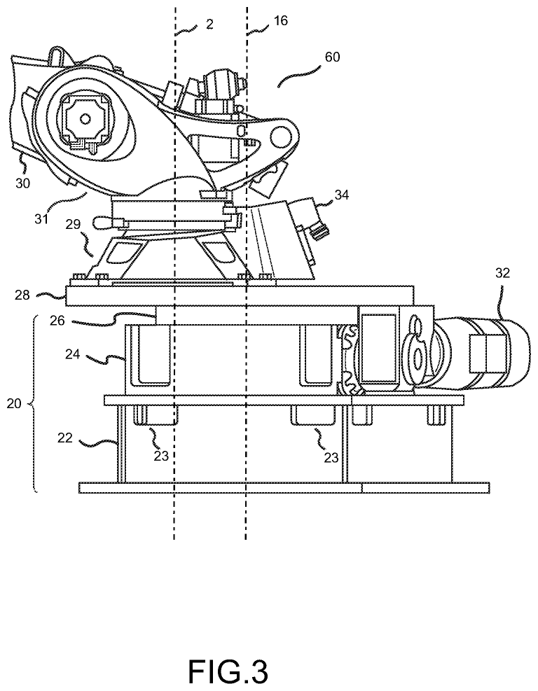

FIG. 3 demonstrates an embodiment of the base assembly 20 of the machining apparatus. In an embodiment, the base assembly 20 may be portioned into discrete sub-structures: a fixed foundation 22, a motor carriage 24 and an actuating plate 26. A motor 32 is and mounted to the motor carriage 24. The motor 32 is operatively connected to the actuating plate 26 through the motor carriage 24 and drives the movable member 28 via a drive mechanism. As would be understood to a person of ordinary skill in the art, the motor 32 may be any machine, powered by electricity, internal combustion or by any other method yet undiscovered, that supplies motive power for the machining apparatus. As further demonstrated by FIG. 3, the sub-structures of the base assembly 20 and the movable member 28 may be arranged about a central vertical axis (e.g., seventh axis 16).

In the embodiment shown in FIG. 3, the fixed foundation 22 is disclosed as a box substructure with forklift apertures 23. However, in an alternative embodiment, the fixed foundation 22 may be a plate or flat structure configured to be fixed to a floor via bolts or screws. This alternative embodiment may allow for increase ease of transport and movement of the machining apparatus. In other embodiments, the fixed foundation 22 may take the form of any style structure configured to receive and support the motor carriage 24.

In the embodiment shown in FIG. 3, the movable member 28 is disclosed as a flat plate. However, in an alternative embodiment, the movable member 28 may be any weldment or single-form structure of varying thickness configured to receive and secure the robotic footing 29 and be driven via the motor 32. The movable member 28 may of a structure to accommodate any potential robotic arm(s) or machining tool(s) of varying mass and configuration as the application requires.

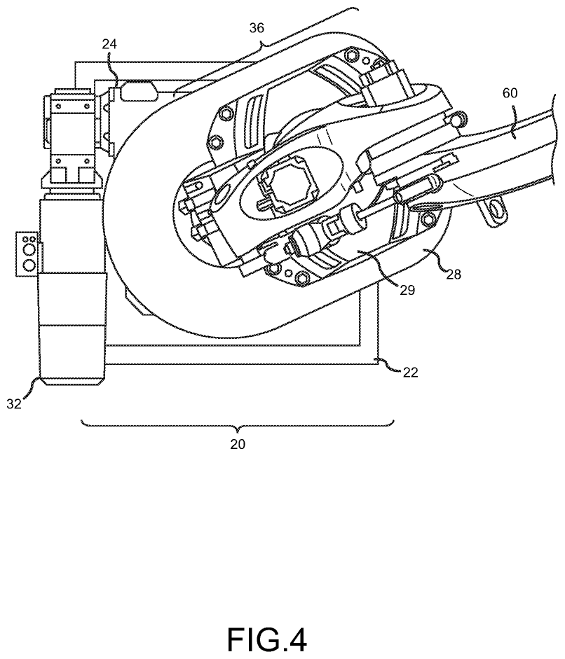

As shown in FIG. 4, the robotic arm 60 may be fixed via the robotic footing 29 to the movable member 28. In an embodiment, the movable member 28 may be asymmetric and rotatably fixed to the center of the actuating plate 26 and comprise mounting surface 36 extending beyond the bounds of the base assembly 20. In an embodiment, the robotic arm 60 may be mounted off-center on the movable member 28 so that it is fixed upon the mounting surface 36. Other embodiments contemplate various orientations of the mounting surface 36 and asymmetries of the movable member 28 that allow the rotational movement of the entire robotic arm 60 beyond the bounds of the base assembly 20.

Returning to FIG. 3, the movable member 28 is influenced by the motor 32 via the actuating plate 26 to rotate about a vertical axis. In an embodiment, the movable member 28 rotates about a vertical axis different than first axis 2, about which the robotic base 31 rotates. In this embodiment, the vertical axis may be seventh axis 16. When so influenced, the mounting surface 36 of the movable member 28 will rotate, carrying along the robotic arm 60. The robotic base 31 and the movable member 28 may rotate independently of each other. As detailed in FIG. 4, the mounting surface 36 is rotated from the original starting position to extend beyond one side or another of the base assembly 20, allowing the robotic arm 60 to perform actions in previously inaccessible areas outside of its original work envelope. In one embodiment, the movable member 28 bearing the robotic arm 60 may achieve a rotation range greater than 360 degrees about a central vertical axis (e.g., a seventh axis 16). Other embodiments may contemplate various off-set locations for fixing the robotic arm 60 to the movable member 28, depending on the application and the target object being affected.

The base assembly 20, including motor carriage 24 and motor 32, is effectively sealed from foreign matter such as dust and debris, as well as other environmental hazards such as water and corrosive slurries that may be present in a manufacturing workspace. The sealing of the base assembly 20 may accomplished about through seal welding, polymer or elastomeric inlays, or by any other method know or yet undiscovered.

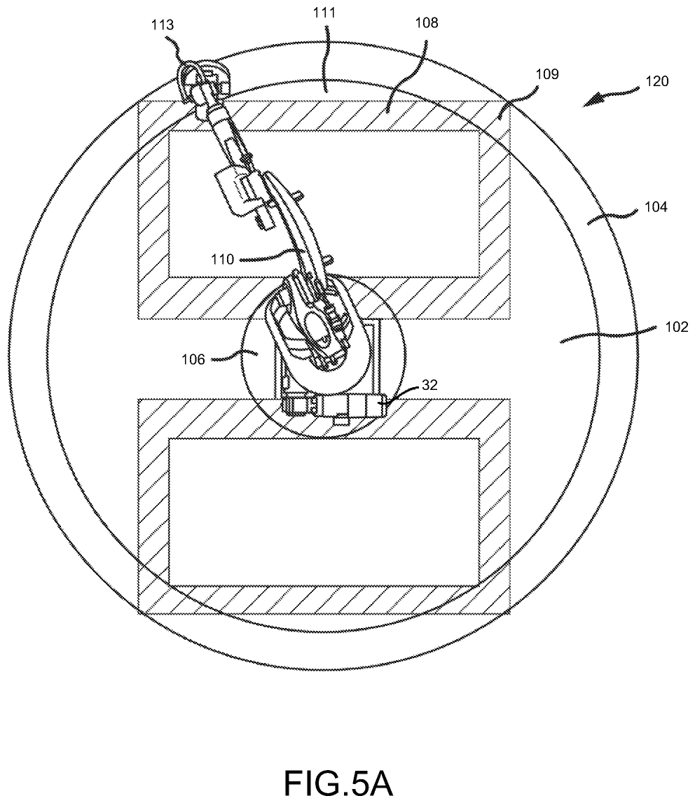

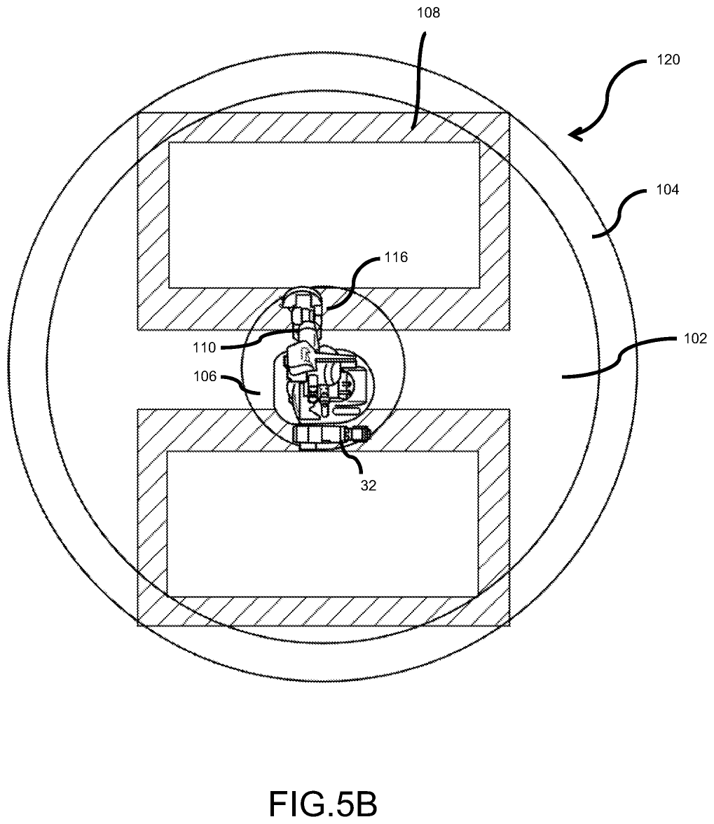

From the above description it can be readily understood that, by the apparatus according to the present disclosure, it is possible to increase the work envelope of the robotic arm 60 and associated machining tool(s) without the presence of a vertical or horizontal track. FIGS. 5A and 5B demonstrates a benefit of a machining apparatus employing the features disclosed in the above embodiments, wherein 110 is a machining apparatus exhibiting the features of the previously described embodiments affecting a target slab 108.

Referring first to FIG. 5A, zone 102 represents the initial work envelope of the machining apparatus 110, that is to say, the work envelope of the machining apparatus 110 when it is positioned perpendicular to the motor 32. As demonstrated, zone 102 fails to the cover portions of the target object 108, in this embodiment a rectangular slab, that rest within the circular zones 104 and 106. For example, the upper right-hand portion 109 of the rectangular slab 108 is outside of the staring work envelope of the un-rotated machining apparatus 110. This is true even as the unrotated machining apparatus may be able to reach portions of the rectangular slab directly in front of it (see 111).

A machining apparatus 110 employing the features disclosed in the above embodiments, enjoys an expanded work envelope, shown in this embodiment as zone 120, which is an aggregate of zones 102, 104, and 106. In one embodiment, the machining apparatus 110 employing the disclosed features will experience a 450 millimeter increase in the outer sphere (i.e., zone 104) of its work envelope as well as a 450 millimeter increase in the inner sphere (i.e., zone 106) of its work envelope when compared to machining apparatus not employing the disclosed features. For example, in the embodiment shown in FIG. 5A, a machining apparatus 110 employing the disclosed features may perform a cut at 113, an area outside of the original work envelope 102.

Referring now to FIG. 5B, the same embodiment of machining apparatus 110 enjoys the expanded work envelope shown as zone 120. By rotating 90 degrees from a neutral position (i.e., perpendicular to the motor 32), a machining apparatus 110 employing the features disclosed in the above embodiments may perform a cut on target object 108 at point 116 within the inner sphere (i.e., zone 106) of its work envelope.

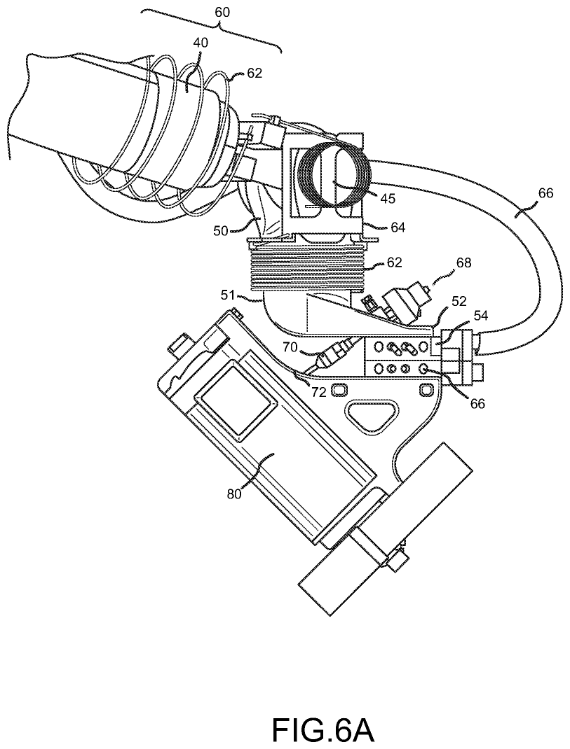

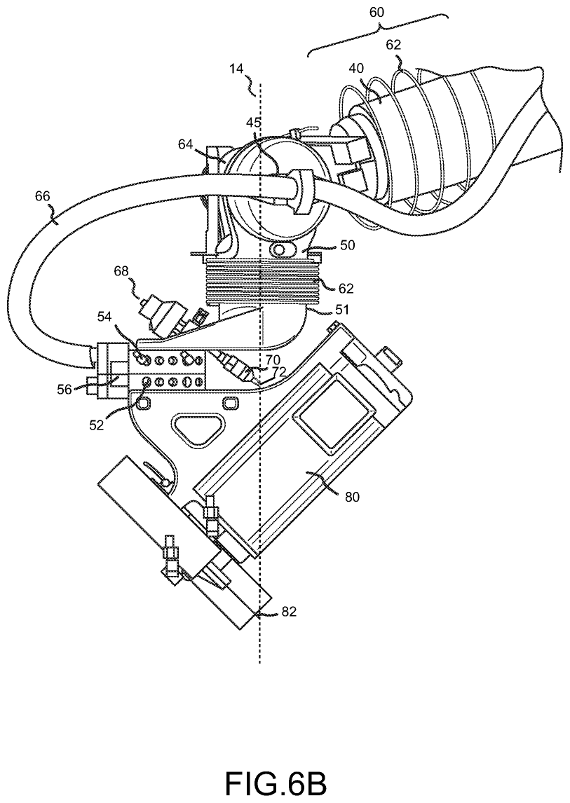

A machining apparatus consistent with the above embodiments may perform miter cuts within the expanded work envelope 120. An apparatus consistent with the above disclosure, in an embodiment, may incorporate cutting tools 70 and 82 with cut points resting about 45 degrees relative to a horizontal surface, such as depicted in FIG. 6B. By leveraging an off-center position on the movable member 28 and synchronous movement, a machining apparatus 110 consistent with the above embodiments may perform miter cuts in zones 104 and 106 of FIGS. 5A and 5B.

Further, from the above description, it can be readily understood that the external zero axis of the machining apparatus 110 employing the features disclosed is parallel to the first axis 2 of the robotic arm 60, both of which are normal to the horizontal working plane of the target slab 108. This allows the machining apparatus at 110 increased flexibility in positioning the other axes of the robotic arm 60 at various locations in the work envelope.

Further, from the above description, it can be readily understood that an apparatus in conformance with the above embodiments may be effectively sealed against environmental debris, dust and other hazards, while allowing a substantial expansion of the original work envelope.

In an embodiment, at the distal end of the robotic arm 60 is a wrist member 50, shown as FIG. 6A and FIG. 6B. The wrist member 50 is operatively connected to the upper member 40 via the wrist joint 45 and laterally manipulatable by the wrist joint 45. Distal to the wrist joint 45 on the wrist member 50 is the tool head 51 operatively connected to the wrist member 50 and rotatably manipulatable by the head rotational member 53 (obscured in FIG. 6B) about the sixth axis 14.

Mounted to the tool head 51 may be a first tool, in an embodiment a water jet cutting tool 70, that is attached to the wrist member 50 so that it is also rotatable manipulatable by the head rotational member 53. The water jet cutting tool 70 is capable of directing a high pressure jet of water onto the target slab at a point 72 along the sixth axis 14, which is formed parallel to the wrist member 50. A further description of this embodiment may refer to the first tool as a water jet cutting tool, but this is not intended to be limiting and the first tool may be any other cutting or affecting device, depending on the specific application or target surface.

As shown in FIG. 6A, the water jet cutting tool 70 may receive water from a first coil 62 that is spirally wrapped upwards around the wrist member 50 until it reaches the wrist joint 45, whereby the first coil 62 is further continuously wrapped around a scaffold structure 64 mounted about the length of the robotic arm 60 until it reaches the base assembly and a water source. In an embodiment, the first coil 62 may be high pressure tube wrapped up the various members of the robotic arm 60 by coiling around each axis for rotational flexibility. Due to the ultra-high pressure and proliferation of deformation seals on the fittings, the first coil 62 will not disconnect automatically, allowing for the coupling and decoupling of the second tool 80 as well as the operation of the second tool 80 as described further herein.

In an embodiment, the water jet cutting tool 70 is configured to receive computerized pre-programmed or real-time instructions through wired means. In an embodiment, the wired means may be communicated through a wiring system that runs along the robotic arm 60 to a computer or manual programing station. In an alternative embodiment, the computerized pre-programmed or real-time instructions may be communication through wireless means that may include radio or cellular protocols, or other standard protocols such as near-field communications (NFC), wireless local area networks, and wireless personal area networks such as BLUETOOTH® and BLUETOOTH® LOW ENERGY.

In one embodiment as shown in FIG. 6A, the water jet cutting tool may rest at approximately a 45 degree angle, with the cut point being similarly angled at approximately a 45 degree angle relative to a horizontal surface but beginning at a point along the sixth axis 14.

In an embodiment, and as further shown in FIG. 6B. At the distal end of the tool head 51 from the wrist member 50, adjacent to the water jet cutting tool 70 in manner not interfering with the operating of the water jet cutting tool 70, is a second tool mount 52. The mount may be configured, in a manner to be further described, to receive a second tool 80. In the description of this embodiment, the second tool 80 will be described as a saw cutting tool, but this is not intended to be limiting. Any additional cutting tool or affecting tool may be operatively mounted to the second tool mount 52 depending on the specific application or target slab to be affected. The second tool mount 52 may be configured as two individual abutting plates 54 and 56 with corresponding mated locking systems.

At 66, FIG. 6B demonstrates a tool cable conduit. In an embodiment, this may be a plastic conduit utilized to route and protect cables, hoses and coils that run from the base to the head of the robotic arm 60. In an embodiment, the tool cable conduit 66 conveys electrical, air and water to the head and attached effecting tool(s). The tool cable conduit 66 may be fixed to the stationary side of the robotic arm 60. In embodiments, the cables, hoses and coils terminate at the abutting plates 54 and 56, which contains pass through modules for delivering water, air and electrical through the second mount 52 and to the second tool 80.

In an embodiment, the second tool 80 (e.g., a saw cutting tool 80) is configured to receive computerized pre-programmed or real-time manual instructions through wired or wireless means. In an embodiment, the wired means may be communicated through a wiring system that runs along the robotic arm to the base or to a computer or manual programing station. In an alternative embodiment, the computerized pre-programmed or real-time instructions may be communication through wireless means that may include radio or cellular protocols, or other standard protocols such as near-field communications (NFC), wireless local area networks, and wireless personal area networks such as BLUETOOTH® and BLUETOOTH® LOW ENERGY.

In one embodiment as shown in FIG. 6B, the saw cutting tool 80 may rest at a 45 degree angle, with the cut point 82 being similarly angled at 45 degrees relative to a horizontal surface but beginning at a point along the sixth axis 14. Through manipulation of the robotic members, joints and movable member along their respective axes, the cut point 82 of the saw cutting tool 80 may be manipulated to any point on the target slab. Similarly, the cut angle may be adjusted from 45 degrees to perpendicular or any other angle relative to the target slab through manipulation of the robotic members, joints and the movable member 28.

In an embodiment, as shown in FIGS. 6A and 6B, the first tool and the second tool may be mounted simultaneously on the tool head 51 of the robotic arm 60. When done so, as further shown in FIG. 6B, the sixth axis 14 runs through the wrist joint 45 and through the cut points 72 and 82 of the first tool (a water jet cutting tool as a non-limiting example) and the second tool (a saw cutting tool as a non-limiting example), respectively. Regardless of the particular manipulation of the wrist joint 45, robotic arm 60 or movable member 28, the cut points of the first and second tools will remain on the same axis (i.e., the sixth axis 14).

The saw cutting tool 80 is capable of making direct cuts onto the target slab at a point along the axis formed by the wrist joint of the robotic arm. The saw cutting tool may perform the cut at an angle other than 90 degrees, or directly in-line with the axis formed by the wrist member 50 (i.e., the sixth axis 14).

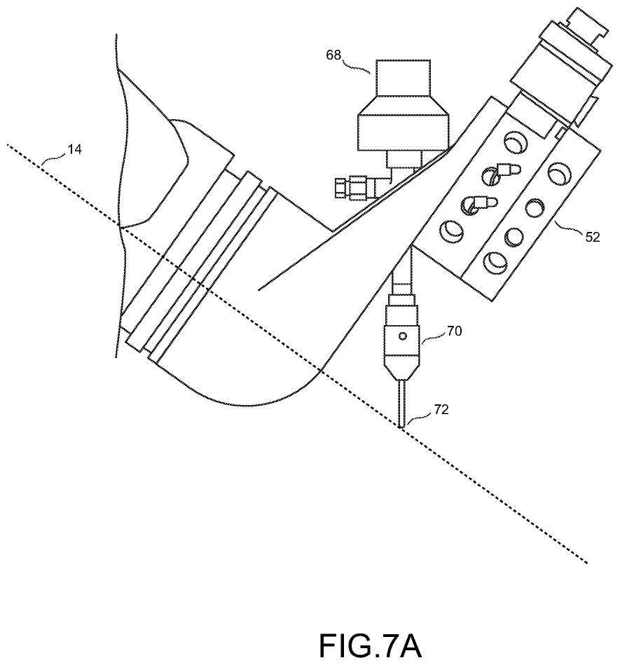

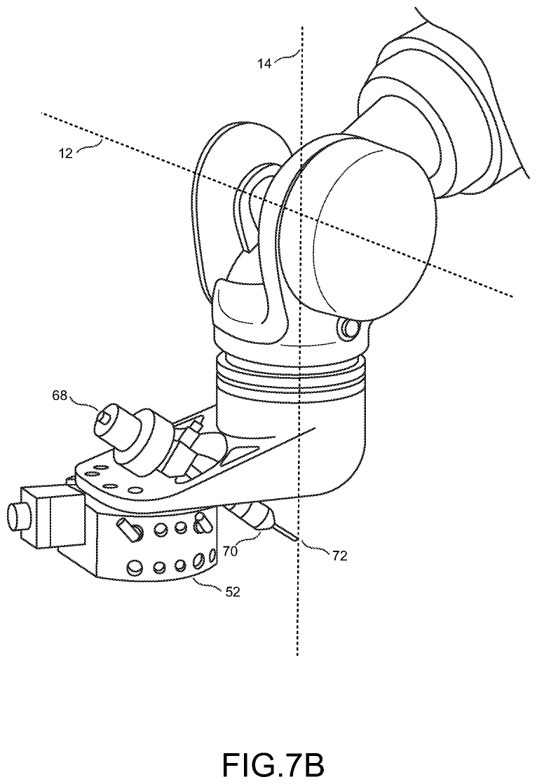

In FIGS. 7A and 7B, a first tool 70 is shown with the second tool detached from the tool head 51. For the embodiment shown in FIGS. 7A and 7B, the first tool 70 is a water jet cutting tool 70. As apparent from FIGS. 7A and 7B, without the second tool 80 attached, the water jet cutting tool 70 may affect a target slab (not shown). When the second tool is detached, the second tool mount 52 remains fixed to the apparatus, but does not obstruct the cut point 72 of the water jet cutting tool 70. FIG. 7A demonstrates the water jet cutting tool 70 angled to perform a cut 90 degrees to a horizontal target slab (not shown). FIG. 7B demonstrates the water jet cutting tool 70 angled to perform a cut 45 degrees to a horizontal target slab (not shown). As further shown in FIG. 7B, the cut point 72 may be laterally manipulated about the fifth axis 12 and rotatably manipulated about the sixth axis 14 to a variety of angles, as required by the application. Distal from the cut point 72 of the water jet cutting tool 70 is a water jet on/off valve 68. In operation, this valve is fed with pressurized air to actuate a contained valve within the water jet cutting tool 70 that turns on the water jet cutting tool 70.

The following is a description, in an embodiment, of how the apparatus couples and decouples the second tool 80 from the second tool mount 52 in order to allow operation of the second tool 80 or the first tool 70, respectively. In this embodiment, coupling and decoupling of the second tool 80 is an automated process. Referring now to FIG. 7A, the first tool 70 remains fixed to the wrist member 50 at all times in the coupling and decoupling process. While in a decoupled state (i.e., with only a single tool attached), as shown in FIG. 7A, the second tool 80 is stationed on a tool rack (not shown). Upon receiving command from an operator or from executed program code, the robotic arm 60 will drop of a cover plate and navigate over to the tool rack. Following the command from the operator or the executed program code, the arm 60 will navigate the wrist member 50 so that the second tool mount 52 moves into position to engage the second tool 80. In an embodiment, the wrist member 50 and second tool mount 52 couple the second tool via a pneumatic locking mechanism and electrical sensors. At this point, the second tool 80 is operable to effect the target slab.

Conversely, in an embodiment, the robotic arm 60 may follow a command from the operator or executed program code to navigate the back to the tool rack, disengage the pneumatic locking mechanism to detach the second tool 80 into an appropriate location on the tool rack, and reattached the mount cover plate. At this point, the first tool 70 is operable to effect the target slab.

It should be understood that a main electronic control unit (i.e., computing unit), as described herein may include conventional processing apparatus known in the art, capable of executing pre-programmed instructions stored in an associated memory, all performing in accordance with the functionality described herein.

Although only certain embodiments have been described above with a certain degree of particularity, those skilled in the art could make numerous alterations to the disclosed embodiments without departing from the scope of this disclosure. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments. Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. Additionally, the terms “electrically connected” and “in communication” are meant to be construed broadly to encompass both wired and wireless connections and communications. It is intended that all matter contained in the above description or shown in the accompanying drawings shall be interpreted as illustrative only and not limiting. Changes in detail or structure may be made without departing from the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While one or more particular embodiments have been shown and described, it will be understood by those of skill in the art that various changes and modifications can be made without departing from the spirit and scope of the present teachings.

We claim:

1. A multi-axis machining apparatus comprising:
a base assembly comprising a motor driving a movable member, wherein the movable member is horizontally fixed relative to a first vertical axis and is rotatable about the first vertical axis;
a multi-axis robotic arm fixed on the movable member; and
a tool head mounted to an end of the multi-axis robotic arm distal to the movable member.

2. The multi-axis machining apparatus of claim 1, wherein the motor influences the movable member via an actuating plate positioned beneath the movable member.

3. The multi-axis machining apparatus of claim 2, wherein the movable member is asymmetrical and comprises a mounting surface that receives the multi-axis robotic arm, wherein the multi-axis robotic arm when mounted on the mounting surface rotates about a second vertical axis.

4. The multi-axis machining apparatus of claim 3, wherein the tool head bears a machining tool.

5. The multi-axis machining apparatus of claim 4, wherein the machining tool can affect a target object defined by a first area when the movable member has rotated a first amount about the first vertical axis, further wherein the machining tool can affect the target object defined by a second area when the movable member has rotated a second amount about the first vertical axis.

6. The multi-axis machining apparatus of claim 5, wherein a portion of the target object contained in the second area but not contained in the first area is not adjacent to the base assembly.

7. The multi-axis machining apparatus of claim 5, wherein a portion of the target object contained in the second area but not contained in the first area is adjacent to the base assembly.

8. The multi-axis machining apparatus of claim 3, wherein the multi-axis robotic arm is movable about six individual axes.

9. A multi-axis machining apparatus comprising:
a multi-axis robotic arm;
a tool head mounted to an end of the multi-axis robotic arm;
a first tool mounted on the tool head; and
a second tool mounted on the tool head.

10. The multi-axis machining apparatus of claim 9, wherein the first tool and the second tool share a vertical axis.

11. The multi-axis machining apparatus of claim 10, wherein the second tool is operable to affect a target object while the first tool is mounted on the tool head.

12. The multi-axis machining apparatus of claim 10, wherein the first tool has a first tool affecting point and the second tool has a second tool affecting point, and further wherein the first tool affecting point and the second tool affecting point both occur on the vertical axis.

13. A multi-axis machining apparatus comprising:
a movable member;
a robotic arm having a first end and a second end, the first end of the robotic arm being operatively associated with the movable member, the movable member being independently movable with respect to the robotic arm;
a tool head operatively associated with the second end of the robotic arm; and
first and second tools being operatively associate with the tool head.

14. The multi-axis machining apparatus of claim 13, further including a base, the movable member being operatively associated with the base.

15. The multi-axis machining apparatus of claim 14, wherein the movable member is rotatably mounted to the base.

16. The multi-axis machining apparatus of claim 13 wherein the movable member includes a center and the robotic arm is attached to the movable member at a position offset from the center of the movable member.

17. The multi-axis machining apparatus of claim 14, wherein the movable member further includes an extended member, the extended member extending beyond the base

18. The multi-axis machining apparatus of claim 17, wherein the robotic arm is operatively associated with the extended member.

19. The multi-axis machining apparatus of claim 13, wherein the first and second tools are selected from the group consisting of a water jet cutting tool and a saw cutting tool.

20. The multi-axis machining apparatus of claim 13, further including a computer to perform machining operations, including movement of the movable member and the robotic arm, which may be guided by the computer to move in synchrony.
